(19) United States
(12) Patent Application Publication
(10) Pub. No.: US 2002/0193105 A1
(43) Pub. Date: Dec. 19, 2002

(54) Dynamic Handling of orphan cells

(76) Inventors: John Gunnar Olsson, Linkoping (SE); Fergal McGlynn, Meath (IE); Javier Ferrer, Paris (FR); John Paul Duffy, Athlone (IE); Anders Lundstedt, Linkoping (SE); Daniel Johansson, Norrkoping (SE); Per Henrik Flordal, Linkoping (SE)

Correspondence Address: JENKENS & GILCHRIST, PC, 1445 ROSS AVENUE, SUITE 3200, DALLAS, TX, 75202, US

(21) Appl. No.: 09/881,229

(22) Filed: Jun. 13, 2001

(51) Int. Cl. H04Q 7/20

(52) U.S. Cl. 455/423; 455/561

(57) ABSTRACT

Method and apparatus for handling a base transceiver station that has become orphaned as a result of a loss of a base station controller. The method includes determining that contact has been lost between a base transceiver station and a primary base station controller that normally controls the base transceiver station, identifying a secondary base station controller to adopt the base transceiver station, and effecting a handover of the base transceiver station from the primary base station controller to the secondary base station controller. The invention ensures that an operator can maintain some level of service to its customers even if it has lost a base station controller, including the ability to handle emergency calls.

### BACKGROUND OF THE INVENTION

1. Field of the Invention

The present invention relates generally to the mobile telecommunications field; and, more particularly, to a method and apparatus for handling base transceiver stations which have become “orphaned” as a result of the loss of a base station controller.

2. Description of Related Art

FIG. 1 is a block diagram illustrating a model of a GSM (Global System for Mobile Communications) telephony system. The GSM system model is generally designated by reference number 10 and includes a Radio Access Network (RAN) generally referred to as a Base Station System (BSS) 12. BSS 12 includes two types of logical nodes: a Base Transceiver Station (BTS) 14 and a Base Station Controller (BSC) 16. In order to support circuit-switched speech or data services, the BSC 16 interworks with a Mobile Switching Center (MSC) 18 via an open (non-proprietary) interface known as an A-interface; and, as such, an MSC, such as MSC 18, can serve one or more BSCs.

Each BSC in a GSM network can control a plurality (typically hundreds) of radio cells. In other words, each BSC, such as BSC 16, interworks with a plurality (hundreds) of BTSs via respective Abis interfaces. Each BTS, such as BTS 14, is responsible for the transmission and reception of radio signals over an air interface, Um, in one cell. Consequently, the number of cells in a GSM BSS equals the number of BTSs in that BSS. As such, the BTSs are geographically distributed to provide adequate radio coverage of a BSC area, which forms part of a GSM Public Land Mobile Network (PLMN).

Each BTS, such as BTS 14, provides the capacity to carry a plurality of connections (calls) between Mobile Stations (MSs), such as MS 22, and respective BSCs. Specifically, in GSM, each BTS is equipped with one or more Transceivers (TRXs). Each TRX (not shown) is capable of handling eight timeslots of a Time Division Multiple Access (TDMA) frame. Furthermore, each such timeslot can be assigned different combinations of logical channels, such as, for example, Broadcast Control Channels (BCCHs) and Common Control Channels (CCCHs), Stand-alone Dedicated Control Channels (SDCCHs), and Traffic Channels (TCHs).

FIG. 2 is a block diagram of an Internet Protocol (IP)-based BSS 100, which has been developed by Ericsson. A more detailed description of such an IP-based BSS is disclosed in commonly-assigned, co-pending U.S. application for patent Ser. No. 09/494,606, the entire disclosure of which is incorporated herein by reference.

Referring to FIG. 2, the IP-based BSS 100 can include three types of nodes connected to an IP network 108. A first node connected to the IP network 108 is a Radio Base Station (RBS) 102. In general, the RBS 102 implements one or more BTSs; and, in addition, provides IP support for the BSS 100. For example, the RBS 102 functions as an IP host and can include an IP router (not shown). The IP router can be used to route payload User Datagram Protocol (UDP) datagrams to one or more Transceivers (TRXs) and also to connect a plurality of RBSs in various topologies.

A second node connected to the IP network 108 is a GateWay (GW) 104. The GW 104 can be used to terminate the A-interface. Also, the GW 104 can perform a conversion from one protocol (e.g., an SS7 protocol) to another protocol (e.g., a Transmission Control Protocol (TCP)/IP). The GW 104 can also include a Media GW (MGW) which functions similarly to existing Transcoder Controllers in an Ericsson implementation of the GSM model. The MGW (not shown) includes a pool of Transcoder/Rate Adaptor (TRA) devices (not shown), which, when allocated, are connected to the A-interface. However, the IP network (e.g., GSM) side of the TRAs in the MGW are connected to respective UDP ports. Preferably, the GW 104 is connected to the IP network 108 via a separate router (not shown).

A third node connected to the IP network 108 is a Radio Network Server (RNS) 106. The RNS 106 corresponds to the BSC used for implementing a GSM model, such as the GSM model 10 illustrated in FIG. 1. A primary difference between the RNS 106 and a BSC is that the RNS does not switch payloads and does not include a Group Switch (GS). As such, the RNS 106 preferably carries signaling only, and includes a pool of processors (e.g., the number of processors determined by capacity requirements). The RNS 106 provides a robust, general purpose distributed processing environment which can be based on a standard operating system such as, for example, SUN/Solaris™. The RNS 106 can serve one or more logical BSCs and is preferably connected to the IP network 108 via a separate router. As such, the payload can be routed directly between the GW 104 and RBS 102, without passing through the RNS' 106 processors. The A-interface signaling is routed between the RNS 106 and GW 104.

In addition to the three nodes 102, 104 and 106, the BSS 100 also includes a Sub Network Manager (SNM) 120. SNM 120 is an operational and maintenance node that enables the cellular network operator to manage all equipment within the BSS 100.

As described above, in a BSS, such as BSS 12 or BSS 100, each BSC controls a different set of BTSs. For one reason or another, however, it sometimes occurs that a BSC fails to operate properly such that it loses contact with the BTSs that it is supposed to control. Such a failure can be as a result of a catastrophic event such as a fire, an earthquake or the like; or a lesser event such as a power failure or the like. In any event, when a BSC failure does occur; the BTSs that are controlled by the failed BSC are “orphaned” and no new phone calls can be made in the cells those BTSs control. This can result in a loss in revenue to the operator and an inconvenience to the subscriber. Furthermore, during the period that the BTSs are orphaned, emergency calls cannot be made in their cells; and this can result in substantial hardship.

### SUMMARY OF THE INVENTION

The present invention provides a method and apparatus for handling a base transceiver station in a mobile telecommunications system that has become orphaned as a result of a loss of a base station controller that normally controls the base transceiver station.

More particularly, according to one aspect thereof, the present invention provides a method for handling a base transceiver station in a mobile telecommunications system that includes a plurality of base station controllers and that has become orphaned as a result of a loss of a primary base station controller that normally controls the base transceiver station. The method comprises the steps of determining that contact has been lost between a base transceiver station and the primary base station controller; identifying a secondary base station controller from among the plurality of base station controllers to adopt the base transceiver station; and effecting a handover of the base transceiver station from the primary base station controller to the secondary base station controller.

The present invention recognizes that in an IP-based RAN (BSS), every node included in the RAN is capable of communicating with every other node. The present invention utilizes this capability to solve the problem of orphaned BTSs by effecting a handover of orphaned BTSs from a primary BSC that loses contact with its BTSs to another, secondary BSC that is capable of accepting control of the BTSs.

According to the present invention, the step of determining that contact has been lost between a BTS and a primary BSC includes embodiments in which the BTS determines that contact has been lost, embodiments in which another BSC determines that contact has been lost and embodiments in which the SNM determines that contact has been lost. The step of identifying a secondary BSC from among the plurality of BSCs to adopt the orphaned BTS includes embodiments in which one of either the BTS, the secondary BSC or the SNM makes such identification. The step of effecting a handover of the BTS from the primary BSC to the secondary BSC includes embodiments which may be initiated by any one of either the BTS, the secondary BSC or the SNM.

According to yet further embodiments of the invention, procedures are provided by which an orphaned BTS that has been adopted by a secondary BSC is “readopted” by the primary BSC when the primary BSC again becomes functioning.

With the present invention, an operator can maintain some level of service to its customers even if it has lost a BSC by enabling new calls to be handled after only a relatively short downtime period. Furthermore, with the present invention, it becomes possible to handle any emergency calls that might occur within a cell handled by an orphaned BTS as soon as the orphaned BTS has been adopted by the secondary BSC.

Yet further advantages and specific features of the invention will become apparent hereinafter in conjunction with the following detailed description of presently preferred embodiments of the invention.

### BRIEF DESCRIPTION OF THE DRAWINGS

FIG. 1 is a block diagram of an existing GSM system model;

FIG. 2 is a block diagram of an IP-based BSS;

FIG. 3 is a flow chart illustrating a method for handling an orphaned BTS according to a first embodiment of the present invention;

FIG. 4 is a flow chart illustrating a method for handling an orphaned BTS according to a second embodiment of the present invention;

FIGS. 5a and 5b are flow charts illustrating a method for handling an orphaned BTS according to a third embodiment of the present invention;

FIG. 6 is a flow chart illustrating a method for handling an orphaned BTS according to a fourth embodiment of the present invention;

FIG. 7 is a flow chart illustrating a method for handling an orphaned BTS according to a fifth embodiment of the present invention; and

FIG. 8 is a flow chart illustrating a method for a primary BSC to readopt an orphaned BTS according to a further embodiment of the present invention.

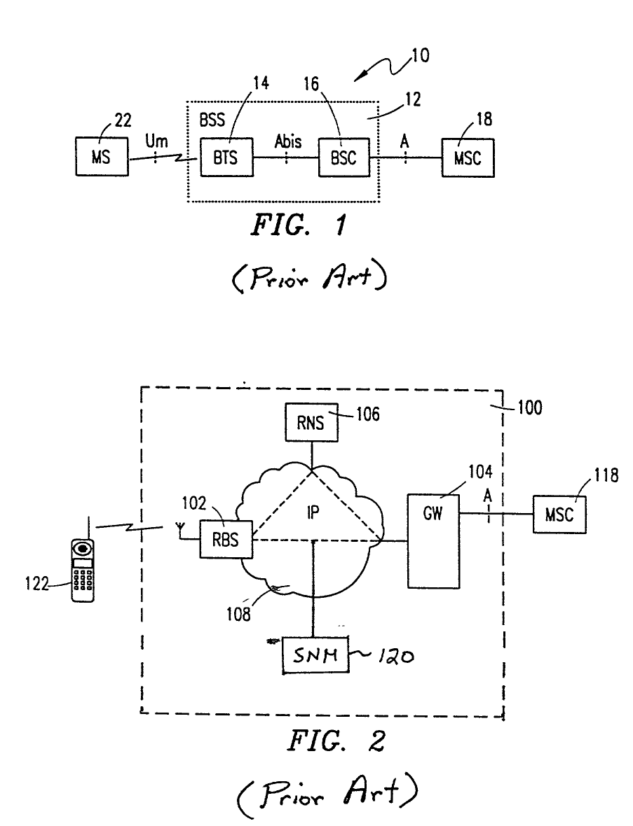

### DETAILED DESCRIPTION OF PRESENTLY PREFERRED EMBODIMENTS

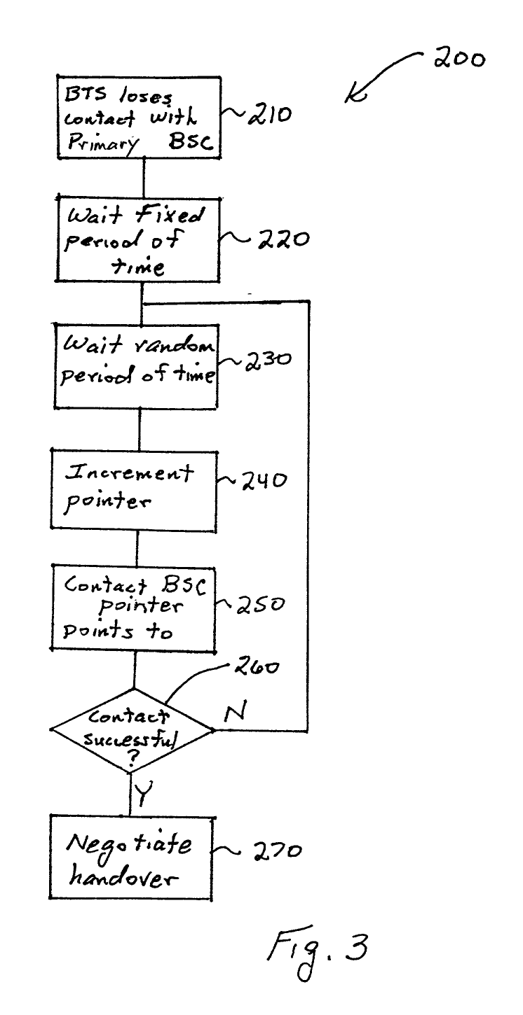

FIG. 3 is a flow chart illustrating a method, generally designated by reference number 200, for handling a BTS which has become orphaned as a result of the loss of its controlling or primary BSC according to a first embodiment of the present invention. In order to perform method 200, each BTS maintains in a memory thereof a list identifying all BSCs in the RAN (BSS) by which it is willing to be controlled, and a pointer into that list. Preferably, the list is prioritized and the first element in the list is the primary BSC, typically the BSC to which the BTS has been assigned by the operator.

The method of FIG. 3 begins when a BTS determines that it has lost contact with its primary BSC (step 210). Following this determination, the BTS waits for a predefined fixed period of time (e.g., about 20 seconds) to make sure that contact with the primary BSC has, in fact, been lost (step 220); and following the fixed period of time, the BTS then waits for a further, random period of time (e.g., from about 0 seconds to about 40 seconds) so as to reduce the likelihood that all BTSs that have lost contact with the same primary BSC contacts the same new BSC at the same time (step 230).

The BTS (which is now an orphaned BTS as a result of its having lost contact with its primary BSC) then endeavors to identify a new, secondary BSC to adopt it. Specifically, the BTS increments the list pointer, i.e., increments the pointer from the first element in the list (which corresponds to the primary BSC and is highest in priority in the list of BSCs by which the BTS is willing to be controlled) to the second element in the list (which corresponds to the BSC in the list that is second highest in priority) (step 240). If the pointer points outside the list, it is reset to point to the second element in the list. The BTS then contacts the BSC that corresponds to the second element in the list and to which the pointer is pointing (step 250).

If the contact is successful, i.e., if the contacted BSC accepts the orphaned BTS, (Y output of step 260), the handover of control of the orphaned BTS from the primary BSC to the new, secondary BSC, i.e., the adopting BSC, is negotiated (step 270). If the contact with the new BSC is unsuccessful, i.e., if the BTS gets no response or a negative response from the contacted BSC (N output of step 260), the process returns to step 230 and the steps 230 to 260 are repeated with the pointer being incremented to the next element in the list in step 240 and the BSC corresponding to that element being contacted in step 250. The process continues until a BSC in the list accepts the BTS (Y output of step 260).

If at any time during the performance of the method 200, the BTS is contacted by the primary BSC, the BTS aborts the method and remains with the primary BSC.

When an orphaned BTS has been adopted by a secondary BSC in accordance with method 200 illustrated in FIG. 3, as well as in accordance with other methods which will be described hereinafter; the secondary BSC can either retrieve cell configuration data from the SNM (Sub Network Manager), or the SNM can push that information into the secondary BSC. The secondary BSC can also retrieve useful information from the adopted BTS itself.

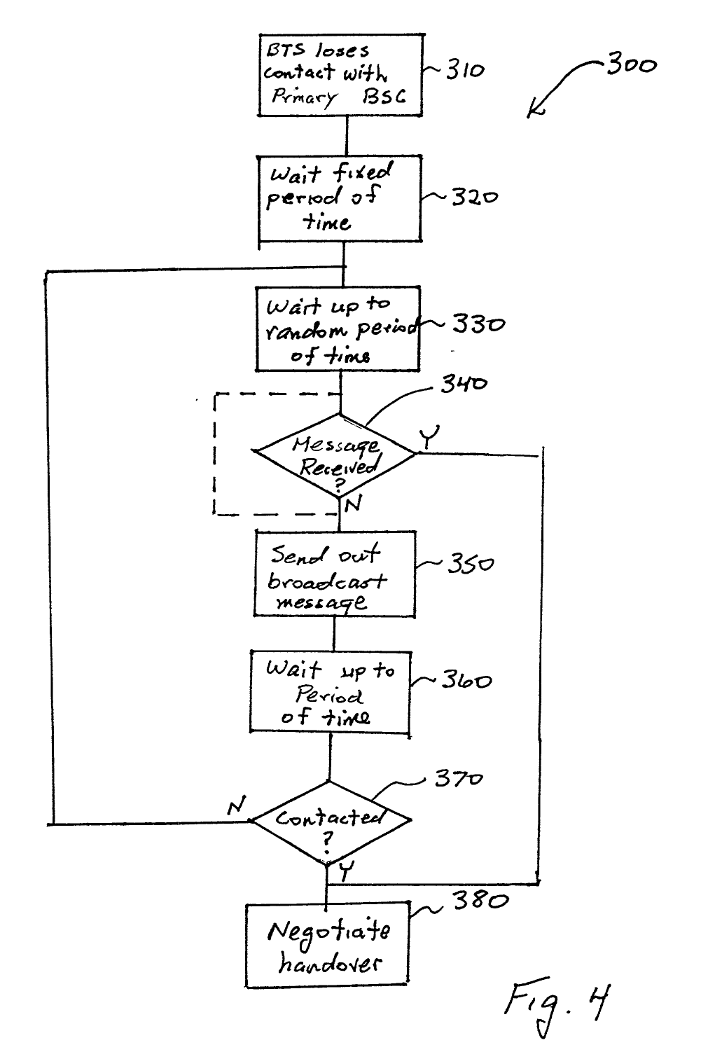

FIG. 4 is a flow chart illustrating a method, generally designated by reference number 300, for handling an orphaned BTS according to a second embodiment of the present invention. In method 300, all BTSs and all BSCs in the RAN subscribe to a special multicast group that is used only for sending out notifications about orphaned BTSs.

As shown in FIG. 4, the method begins when a BTS determines that it has lost contact with its primary BSC (step 310). As in the previous embodiment, the BTS then waits for a predefined fixed period of time (step 320) to ensure that contact with the primary BSC has, in fact, been lost. Thereafter, the BTS then waits for up to a random period of time (step 330), and if the BTS has not received a message from another BTS during the wait (N output of step 340); the BTS sends out a broadcast message to the multicast group advising that contact with its primary BSC has been lost (step 350). The BTS then waits for up to a period of time; for example, for up to a predefined fixed period of time (e.g., about 60 seconds), and for up to a further random period of time (e.g, from about 0 seconds to about 20 seconds) for an answer to the broadcast message it sent out (step 360). If it is not contacted by a BSC (or if it does not receive a message from another BTS) by the end of the period of time, (N output of step 370), it sends a new broadcast message (i.e., the method returns to step 330). If the BTS is contacted by a BSC or if it receives a message from another BTS (Y output of step 370), a handover is negotiated with the contacting BSC (step 380).

In the method of FIG. 4, when a BTS sends a message to the multicast group, the BTS will also receive the sent message since it is a part of the multicast group. Accordingly, some kind of identification code is included in the sent message, and a filtering mechanism is included in the BTS in order to ensure that the BTS does not receive any messages that it sends out.

When a BSC is notified, via a broadcast message sent out in step 350, that there is an orphaned BTS, the BSC can take several possible actions. Examples of such possible actions include:

1. The BSC can maintain a list of all BTSs in the RAN and the BSCs by which they are controlled. When an orphaned BTS is detected, the adopting BSC is able to identify the BSC that controlled the orphaned BTS, i.e., the primary BSC for that BTS; and, from this information, can identify all of the other BTSs controlled by that BSC without having to wait for each BTS to individually cry out for help. According to this procedure, therefore, if a BTS receives a message from another BTS in step 340 (Y output of step 340), it will not have to send out its own message because it is able to be identified by the adopting, i.e., secondary BSC. The method, accordingly, can proceed directly to the negotiating step 380 as shown in FIG. 4. Similarly, if the BTS receives a message from another BTS in step 370 (Y output of step 370), the method also proceeds directly to the negotiating step 380. A disadvantage of this procedure is that each BSC must always maintain a fully updated list of all BTSs in the RAN.

2. The BSC can also adopt each BTS as it receives a separate broadcast message from each BTS that has been orphaned by the primary BSC. In this procedure, step 340 of the method is unnecessary as there is no reason for a BTS to wait to see if it gets a message from another BTS or from a BSC; and it simply sends out a broadcast message to the multicast group after waiting the random period of time. This is illustrated by the dashed line in FIG. 4 extending directly from step 330 to step 350. In this procedure also, the BTS will only wait in step 360 to be contacted by a BSC (Y output of step 370) as it will not be contacted by another BTS. A drawback of this procedure is that it might take some period of time until all of the orphaned BTSs have been adopted.

3. When a BSC receives a message broadcast by a BTS in step 350, the BSC can then contact the SNM in order to obtain a list of all the other BTSs that are controlled by the same BSC as the orphaned BTS that sent the message, and that it should also adopt. A drawback of this procedure is that the adopting BSC is unable to do anything until it contacts and receives the list of BTSs from the SNM.

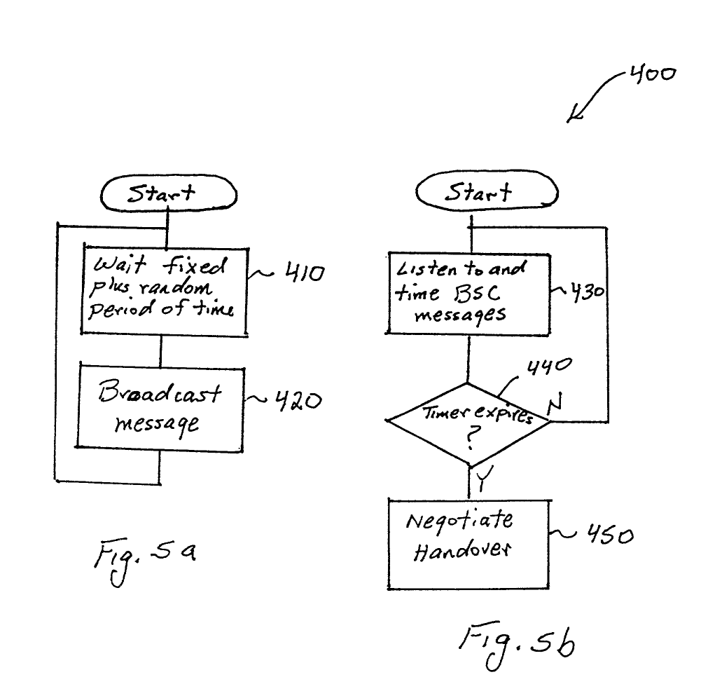

FIGS. 5a and 5b are flow charts illustrating a method for handling an orphaned BTS according to a third embodiment of the present invention. In this method, generally designated by reference number 400, each BSC regularly broadcasts a message using multicast to all other BSCs in the RAN advising that it is alive and functioning properly. Such message should contain sufficient information so that it will be easy to map it to the sending BSC. More specifically, as shown in FIG. 5a, the method begins with the step of waiting a predefined fixed period of time plus a random period of time (step 410). This will ensure that the broadcast messages are spread out over time. The broadcast message is then sent out (step 420); and as shown in FIG. 5a, the broadcast message will continue to be sent out on a regular basis by repeating steps 410 and 420.

In parallel with repeatedly sending out a broadcast message as shown in FIG. 5a, the method illustrated in FIG. 5b is performed. Specifically, the BSC listens to multicasts sent out by other BSCs (step 430), filtering out the messages that the BSC itself has sent so that it won't receive its own messages. The BSC has a timer running for each BSC that it knows about. Each timer is preferably set to a time greater than the maximum time between multicast messages in order to prevent jitter, and if any timer expires (Y output of step 440), it starts adopting BTSs that were controlled by that BSC (step 450). In other words, if the BSC doesn't receive a message from another BSC within the time set by its associated timer; it knows that the BSC is no longer operating and begins to adopt its BTSs. The list of BSCs maintained by each BSC is preferably dynamically built from the messages it has received, although it can also be a static list, in which case it is required that the list be maintained current in sonie manner. The list of all the BTSs that the BSC should adopt can be stored statically in the BSC, or the BSC can contact the SNM to obtain the list.

In the method illustrated in FIG. 5b, rather than a BSC listening to multicasts sent out by all other BSCs in the RAN, as described above, step 430 can comprise listening only to those multicasts sent out by one or more “buddy” BSCs. If it loses contact with a buddy BSC, it adopts the BTSs that the buddy BSC controlled. If several BSCs are buddies with one BSC, the several buddy BSCs can share the load necessitated by the adoptions.

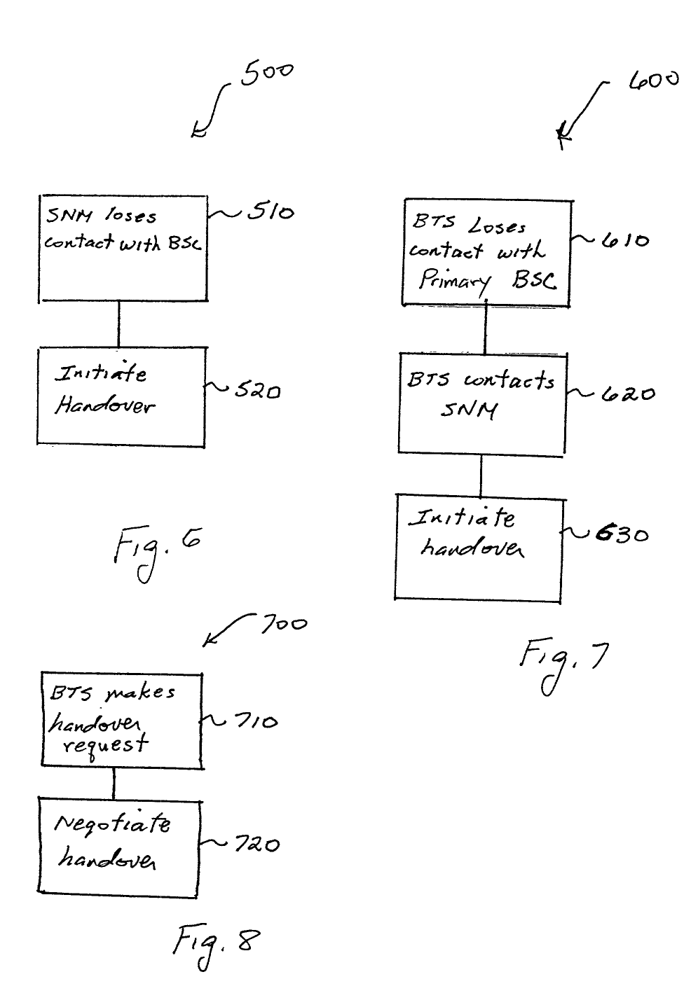

FIGS. 6 and 7 are flow charts illustrating methods for handling an orphaned BTS according to yet further embodiments of the present invention. In the method of FIG. 6, generally designated by reference number 500, the SNM monitors all the BSCs in the RAN. When it determines that it has lost contact with a BSC (step 510), it initiates the handover of BTSs controlled by that BSC by contacting other suitable BSCs in the RAN and asking if they can adopt the orphaned BTSs (step 520). In the method of FIG. 7, generally designated by reference number 600, when a BTS determines that it has lost contact with its primary BSC (step 610), it contacts the SNM for advice (step 620). The SNM then initiates the handover of the orphaned BTS, and of other BTSs controlled by the same BSC, to a secondary BSC by either ordering the BTSs to contact a specific BSC or by ordering a specific BSC to contact the BTSs (step 630). Although not illustrated in FIGS. 6 and 7, methods 500 and 600 preferably also include steps of waiting a period of time after contact with a BSC is lost to make sure that contact has, in fact, been lost.

After an orphaned BTS has been adopted from a malfunctioning primary BSC by a secondary BSC, when the primary BSC is again alive and functioning properly, a readoption procedure is preferably initiated to enable the primary BSC to readopt its BTS. FIG. 8 illustrates a readoption method according to a further embodiment of the present invention. The readoption method is generally designated by reference number 700; and, in performing the method, it is assumed that a primary BSC has been unavailable for some period of time and that it controlled an orphaned BTS that was adopted by a secondary BSC. The method is initiated by a handover request made by the BTS (step 710); and, thereafter, the handover of the BTS from the secondary BSC back to the primary BSC is negotiated (step 720).

The handover request of step 710 can be accomplished in different ways. In one embodiment, the BTS notifies the primary BSC that it was adopted by the secondary BSC. In this procedure, it is up to the primary BSC to initiate contact with the secondary BSC; and the handover negotiation is carried out by the primary BSC, the secondary BSC and the BTS. In an alternative embodiment, the BTS notifies the secondary BSC that it no longer wants to be adopted by the secondary BSC. In this procedure, all negotiation of the handover of the BTS back to the primary BSC is carried out through the BTS.

With the present invention, as described above, an operator is able to maintain some level of service to its customers, even if it has lost a BSC for some reason. This will preserve income to the operator and minimize inconvenience to the customer. In addition, emergency calls will be able to be handled by an orphaned BTS as soon as it has been adopted by a secondary BSC, ensuring that this important service is maintained.

It should be emphasized that the term “comprises/comprising” when used in this specification is taken to specify the presence of stated features, integers, steps or components but does not preclude the presence or addition of one or more other features, integers, steps, components or groups thereof.

It should also be recognized that while what has been described herein constitutes presently preferred embodiments of the invention, the invention can be varied in numerous ways without departing from the scope thereof. Accordingly, it should be understood that the invention should be limited only insofar as is required by the scope of the following claims.

1. In a mobile telecommunications system that includes a plurality of base station controllers, a method for handling a base transceiver station that has become orphaned as a result of a loss of a primary base station controller that normally controls the base transceiver station, the method comprising:
determining that contact has been lost between said base transceiver station and said primary base station controller;
identifying a secondary base station controller from among said plurality of base station controllers to adopt said base transceiver station; and
effecting a handover of said base transceiver station from said primary base station controller to said secondary base station controller.

2. The method according to claim 1, wherein said determining step comprises said base transceiver station determining that contact has been lost between said base transceiver station and said primary base station controller.

3. The method according to claim 2, wherein said base transceiver station includes a memory having a list identifying base station controllers by which said base transceiver station is willing to be controlled, and wherein said identifying step) includes said base transceiver station contacting base station controllers identified in said list one at a time until said secondary base station controller is identified.

4. The method according to claim 3, wherein said list is a prioritized list, and wherein said base transceiver station contacts base station controllers identified in said list one at a time in order of priority.

5. The method according to claim 4, wherein said primary base station controller is the base station controller identified in said prioritized list which is of highest priority.

6. The method according to claim 3, and further including the step of said base transceiver station waiting a period of time after determining that contact has been lost between said base transceiver station and said primary base station controller before contacting base station controllers identified in said list.

7. The method according to claim 6, wherein said step of waiting a period of time comprises waiting a first fixed period of time and thereafter waiting a second random period of time.

8. The method according to claim 2, wherein said identifying step includes said base transceiver station sending a broadcast message to said plurality of base station controllers.

9. The method according to claim 8, wherein said plurality of base station controllers comprises all base station controllers in a base station system of said mobile telecommunications system.

10. The method according to claim 8, and further including the step of said base transceiver station waiting a period of time after determining that contact has been lost between said base transceiver station and said primary base station controller before sending said broadcast message.

11. The method according to claim 10, wherein said period of time includes a first fixed period of time and up to a second random period of time.

12. The method according to claim 11, and further including the step of said base transceiver station waiting up to a third period of time after sending said broadcast message for a response thereto, and repeating the step of sending a broadcast message if a response is not received within said third period of time.

13. The method according to claim 2, wherein said identifying step includes said base transceiver station contacting a sub network manager of said mobile telecommunications system, and wherein said step of effecting a handover includes said sub network manager initiating said handover.

14. The method according to claim 13, wherein said identifying step comprises said sub network manager contacting one or more of said plurality of base station controllers to identify said secondary base station controller.

15. The method according to claim 13, wherein said identifying step comprises said sub network manager ordering one of said plurality of base station controllers to be said secondary base station controller.

16. The method according to claim 1, wherein said determining step comprises abase station controller of said plurality of base station controllers determining that contact has been lost between said base transceiver station and said primary base station controller.

17. The method according to claim 16, wherein each base station controller of said plurality of base station controllers sends a broadcast message to others of said plurality of base station controllers, and wherein each base station controller includes timers which time the broadcast messages sent from said others of said base station controllers, and wherein said determining step includes determining that contact has been lost between said base transceiver station and said primary base station controller when a timer associated with said primary base station controller expires without a message having been received from said primary base station controller.

18. The method according to claim 17, wherein said others of said plurality of base station controllers comprise predetermined ones of said plurality of base station controllers.

19. The method according to claim 1, wherein said mobile telecommunications system includes a sub network manager, and wherein said determining step comprises said sub network manager determining that contact has been lost between said base transceiver station and said primary base station controller.

20. The method according to claim 19, wherein said identifying step comprises said sub network manager contacting one or more of said plurality of base station controllers to identify said secondary base station controller.

21. The method according to claim 1, and further including the step of said primary base station controller readopting said base transceiver station when contact is able to be reestablished between said base transceiver station and said primary base station controller.

22. The method according to claim 21, wherein said readopting step comprises said base transceiver station requesting readoption of said primary base station controller.

23. The method according to claim 21, wherein said readoption step comprises said base transceiver station advising said secondary base station controller that it wishes to be readopted by said primary base station controller.

24. A mobile telecommunications system comprising:
a base station system, said base station system including a plurality of base station controllers, each of which controls at least one base transceiver station;
a determiner that determines that contact has been lost between a base transceiver station and a primary base station controller that normally controls said base transceiver station;
an identifier that identifies a secondary base station controller of said plurality of base station controllers to adopt said base transceiver station; and
handover means for handing over said base transceiver station from said primary base station controller to said secondary base station controller.

25. The mobile telecommunications system according to claim 24, wherein said base transceiver station includes a memory for storing a list of elements identifying base station controllers among said plurality of base station controllers in said base station system by which it is willing to be controlled, and a pointer which points to an element in said list to identify a potential secondary base station controller.

26. The mobile telecommunications system according to claim 24, wherein said identifier includes a transmitter in said base transceiver station for transmitting a broadcast message to said plurality of base station controllers, and a receiver in said plurality of base station controllers for receiving a response to said broadcast message.

27. The mobile telecommunications system according to claim 24, wherein said determiner includes a transmitter in said primary base station controller for transmitting a broadcast message to others of said plurality of base station controllers, and wherein said others of said plurality of base station controllers include a receiver for receiving said broadcast message and a timer for determining that said broadcast message has not been received in a period of time.

28. The mobile telecommunications system according to claim 24, wherein said base station system further includes a sub network manager, and wherein said determiner is in said sub network manager.
